(19) United States
(12) Patent Application Publication
(10) Pub. No.: US 2005/0194756 A1
(43) Pub. Date: Sep. 8, 2005

(54) Modular machine for the storage or transportation of compressed gas cylinders

(76) Inventor: Sean Stavros Farley, Woodland Hills, CA (US)

Correspondence Address: Sean Stavros Farley, 4450 Shopping Lane, Simi Valley, CA, 93063, US

(21) Appl. No.: 10/790,593

(22) Filed: Mar. 2, 2004

(51) Int. Cl. B62B 3/00

(52) U.S. Cl. 280/79.3

(57) ABSTRACT

A modular machine for the storage or transportation of compressed gas cylinders with A Top Grill, A Bottom Grill, A pair of Handles or 4 Posts, 8 pair of Plastic Bushings, and 4 Casters for cart version.

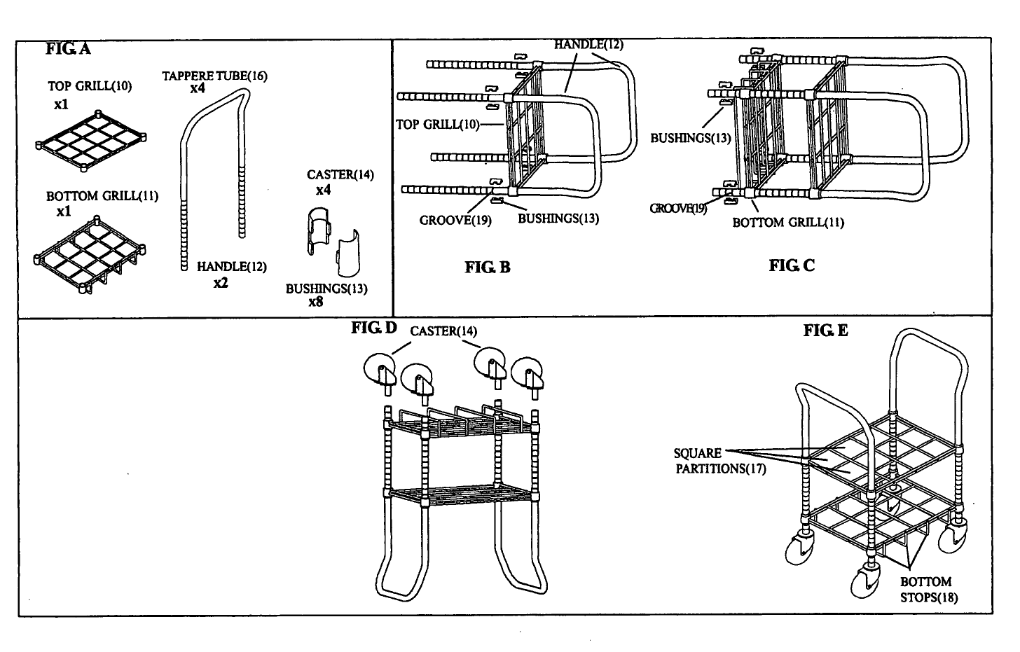

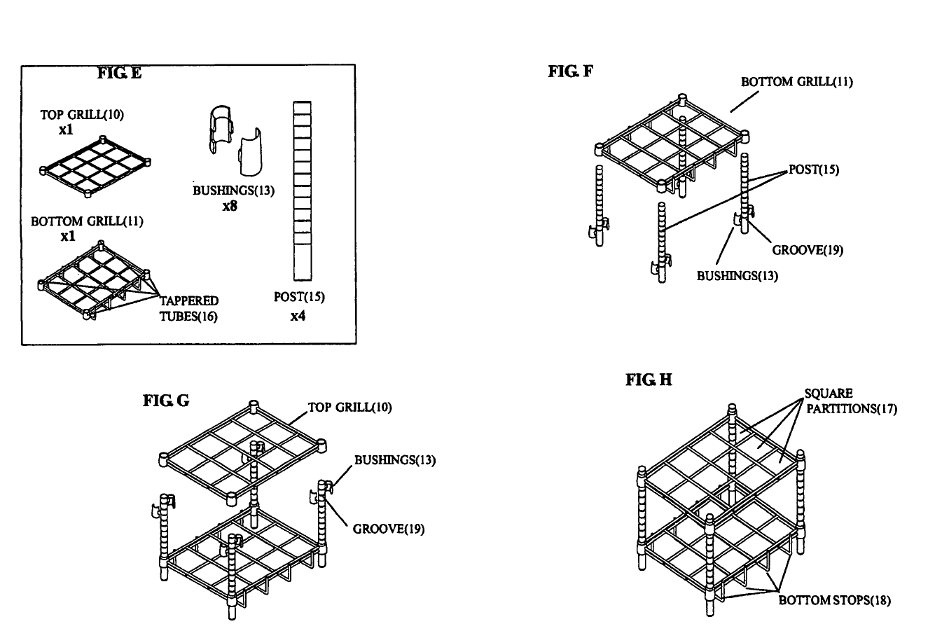

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of transportation and storage and more specifically to a modular machine for the storage or transportation of compressed gas cylinders.

The storage and transportation of compressed gas cylinders has been around since the compressed gas cylinder. Safety regulations and guidlines required by OSHA and DOT place certain guidlines to the storage and transportation of compressed gas cylinders due to the high pressure and the danger associated with this high pressure.

Cylinder carts and racks have been designed and manufactured by various companies for years. They are comprised of all welded steel construction.

The shortcomings of previous technology is that units are one piece all welded construction. Shipping and storage of these units Is very costly. Manufacturing of these units is very expensive.

### BRIEF SUMMARY OF THE INVENTION

The primary object of the invention is to manufacture a modular unit.

Another object of the invention is modular units are cheaper to manufacture.

Another object of the invention is modular units are cheaper to ship since units are shipped knocked down.

Yet another object of the invention is units are easilly assembled.

Still yet another object of the invention is the cart units have dual lifting handles.

Another object of the invention is the rack units have bolt down tabs on each feet.

Another object of the invention is that units are made up of a strong lightweight steel construction.

A further object of the invention is that there are many different configurations.

Yet another object of the invention is that units assemble with the use of a mallet or hammer. No other tools are needed.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a modular machine for the storage or transportation of compressed gas cylinders. comprising: A Top Grill with square partitions, A Bottom Grill with square partitions, A pair of Handles or 4 Posts, 8 pair of Plastic Bushings, and 4 Casters for cart version.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

Figure A is an exploded view which shows all components for a cart assembly.

Figure B is a perspective view of the invention which shows how the Handles (12) are attached to the Top Grill (10) with the use of the Plastic Bushings (13) which are snapped onto the Grooves (19) on the Handles (12).

Figure B also shows how the Bottom Grill (11) is attached to the Handles (12) with the use of the Plastic Bushings (13) which are snapped onto the Grooves (19) on the Handles (12).

Figure C is a perspective view of the invention which shows how the Casters (14) are attached to the bottom of the unit through the Handles (12).

Figure D is a perspective view of the completely assembled cart invention.

Figure E is an exploded view which shows all components for a rack assembly.

Figure F is a perspective view of the invention which shows how the Posts (15) are attached to the Bottom Grill (11) with the use of the Plastic Bushings (13) which are snapped onto the Grooves (19) on the Posts (15).

Figure G shows how the Top Grill (10) is attached to the Posts (15) with the use of the Plastic Bushings (13) which are snapped onto the Grooves (19) on the Handles (12).

Figure H is a perspective view of the completely assembled rack invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

A modular machine for the storage or transportation of compressed gas cylinders. Units are made up of modular components comprising of a Top Grill (10) with Square Partitions (17); A Bottom Grill (11) with Square Partitions (17); A pair of Handles (12) or 4 Posts (15); 8 pair of Plastic Bushings (13); and 4 Casters (14) for the cart version.

The cart and racking system is a modular design that will help reduce the costs associated in shipping, manufacturing and the storage of units. When unit is assembled compressed gas cylinders are stored in a verticle fashion. Each cylinder is seperated by Square Partitions (17) on the Top Grill (10) and Bottom Grill (11). The cylinder first slides throught the Top Grill (10) and passes down through the Bottom Grill (11) there is a Bottom Stop (18) on the bottom of the Bottom Grill (11) which stops the compressed gas cylinder from hitting the floor. Depending on the requirments unit may have a 4 cylinder capacity up to a 100 cylinder capacity. This is done by the addition of Square Partitions (17) to the Top Grill (10) and Bottom Grill (11).

In accordance with the present invention, Figure A shows all the modular components necessary for the assembly of a cart unit. The assembly is comprised of 5 seperate modular components. A Top Grill (10), a Bottom Grill (11) 8 pairs of plastic bushings (13), a pair of Handles (12) and 4 Casters (14).

In accordance with the present invention, Figure B shows how the Top Grill (10) having 4 Tappered Tubes (16) attached to each of its four corners, is attached to the Handle (12) with the use of the Plastic Bushings (13) snapping together around the Handle (12) onto the Grooves (19) which circumnavigate each Handle (12) and the Top Grill (10) slides down over the Plastic Bushings (13) creating a friction lock joint. The Bottom Grill (11) having 4 Tappered Tubes (16) attached to each of its four corners, is attached by sliding over the the Handles (12) and the plastic bushings (13), creating a friction lock joint when downward pressure is applied.

In accordance with the present invention, Figure C shows how the Casters (14) are attached to the unit through the bottom of the Handles (12), and a grip stem, locks them in place to the Grooves (19) on the bottom of the Handle (12).

In accordance with the present invention, Figure E shows all the modular components necessary for the assembly of a rack unit. The Assembly is comprised of 4 seperate modular components. A Top Grill (10), a Bottom Grill (11), 8 pairs of Plastic Bushings (13), and 4 Posts (15).

In accordance with the present invention, Figure F shows how the Top Grill (10) having 4 Tappered Tubes (16) attached to each of its four corners, is attached to the Posts (15) with the use of the plastic bushings (13) snapping together around the Posts (15) onto the grooves on the Posts (15) and the Top Grill (10) slides down over the Plastic Bushings (13) creating a friction lock joint. The Bottom Grill (11) having 4 Tappered Tubes (16) attached to each of its four corners, is attached in the same manner. The Bottom Grill (11) slides over the the Posts (15) and the Plastic Bushings (13), creating a friction lock joint when downward pressure is applied.

While the invention has been described in connection with a preferred embodiment, it is not intended to limit the scope of the invention to the particular form set forth, but on the contrary, it is intended to cover such alterative, modifications, and equivalents as may be included within the spirit and scope of the invention as defined by the appended claims.

1. A modular machine for the storage or transportation of compressed gas cylinders comprising:
A Top Grill;
A Bottom Grill;
A pair of Handles or 4 Posts;
8 pair of Plastic Bushings; and
4 Casters for cart version.
